(19) United States
(12) Patent Application Publication
(10) Pub. No.: US 2014/0239657 A1
(43) Pub. Date: Aug. 28, 2014

(54) Pneumatic Carrier Extraction Device

(71) Applicant: Calvin Charles Gorham, II, Lubbock, TX (US)

(72) Inventor: Calvin Charles Gorham, II, Lubbock, TX (US)

(21) Appl. No.: 13/777,089

(22) Filed: Feb. 26, 2013

(51) Int. Cl. B25J 1/00

(52) U.S. Cl. CPC B25J 1/00
USPC 294/175; 294/26

(57) ABSTRACT

A component extraction device for a pneumatic carrier employs a hooking mechanism to select and dislodge a wedged carrier within a pneumatic tube assembly. The hooking mechanism is activated by springs when the carrier contacts the integral locking hinge thus enabling the hook to select the carrier in order for extraction from the tube.

### BACKGROUND OF THE INVENTION

Pneumatic tube carriers often become wedged in locations within pneumatic tube assemblies that are inaccessible without dismantling the entire assembly. The causes of carriers becoming lodged include, but are not limited to, overloading and improper use.

### BRIEF SUMMARY OF THE INVENTION

The Pneumatic Carrier Extraction Device mechanism enables a wedged carrier to be selected and dislodged with minimal disassembly.

### BRIEF DESCRIPTION OF THE SEVERAL VIEWS OF THE DRAWING

FIG. 1A depicts a plan view of the device.

FIG. 2A depicts an elevation view of the device.

FIG. 3A depicts a perspective view of the device.

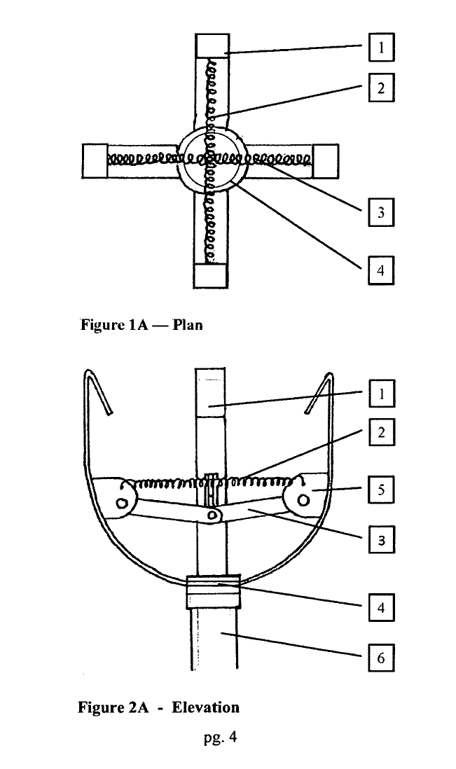

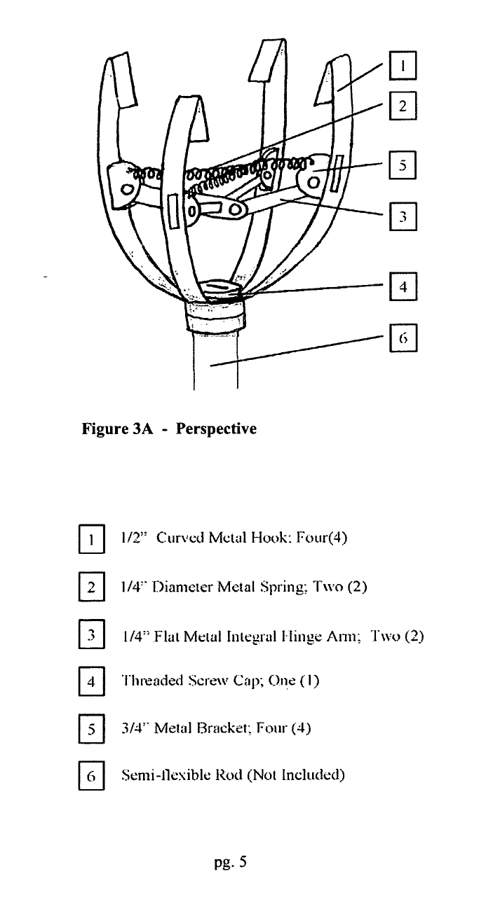

### DETAILED DESCRIPTION OF THE INVENTION

A metal component extraction device for a pneumatic carrier employs a hooking mechanism to select and dislodge a wedged carrier within a pneumatic tube assembly. The hooking mechanism is activated by springs when the carrier contacts the integral hinge arm thus enabling the hook to select the carrier in order for extraction from wedged location in the pneumatic tube assembly. Items 1, 3, and 5 in the Figures below are manufactured through the use of a computer numerical control machine. Metal springs, rivets, and screw caps—items 2 and 4 in the Figures below—are installed to complete the assembly of the device.

1. The device hooking mechanism will catch on the ridge that is common in the design of the carriers.

2. The device will allow access to the carrier with less disassembly required as compared to traditional methods of carrier extraction.

3. The device will attach to rod not included in this assembly.
